(19) United States
(12) Patent Application Publication
(10) Pub. No.: US 2011/0126942 A1
(43) Pub. Date: Jun. 2, 2011

(54) Manually Operable Log Splitter

(76) Inventors: Marcus R. Larson, Redwood City, CA (US); Michael G. Crowell, Coupeville, WA (US)

(21) Appl. No.: 12/628,995

(22) Filed: Dec. 1, 2009

(51) Int. Cl. B27L 7/06

(52) U.S. Cl. 144/366; 144/195.5; 144/193.1

(57) ABSTRACT

A manually-operable log splitter for use with a splitting wedge has a pair of jaws pivotable about a point. Each jaw is connected to a handle extending away from its associated jaw from the pivot point. The jaws have a tip smaller than a width of the splitting wedge with which the splitter is used. The jaws and handles are dimensioned and configured for insertion beside the splitting wedge when embedded in a log. Manual application of force F on each handle outward from the pivot point spreads the jaws and provides sufficient force for splitting the log. This tool is particularly suited for small scale log splitting, such as by a home owner for personal use.

### RELATED APPLICATIONS

This application is related to U.S. patent application Ser. No. 06/313,747 filed Oct. 22, 1981, entitled MANUALLY OPERABLE LOG SPLITTER, which is incorporated herein by reference in its entirety, and claims any and all benefits to which it is entitled therefrom.

### FIELD OF THE INVENTION

This invention relates to a hand-operated tool for splitting logs. More particularly, it relates to such a tool which may be used to complete the splitting of a log rapidly and conveniently when a splitting wedge is embedded in the log.

### BACKGROUND OF THE INVENTION

In the use of a splitting wedge and sledge hammer for splitting logs, a substantial percentage of the time the wedge will become embedded in the log without completing the splitting of the log into two pieces. Further, many logs require multiple blows to complete the splitting, even if the wedge does not become embedded in the log without completing the splitting. The use of crow-bars and similar tools to free an embedded wedge is time consuming and difficult. The use of multiple blows to split the log increases the amount of labor expended to complete the task.

Various techniques have been proposed in the art as a substitute for the use of splitting wedges in an effort to avoid these problems in their use. For example, various J hydraulically operated log-splitting devices and log splitters driven from motor vehicle drive wheels are employed for high volume log splitting. Further, U.S. Pat. No. 4,222,549, issued Sep. 16, 1980, discloses a pressurized device powered by the pressure of a chain saw internal combustion engine cylinder for splitting logs.

While some power-operated devices have achieved acceptance in commercial wood lots and other high volume wood splitting situations, they are of limited suitability for small scale use, such as by home owners who split E their own wood, due to their expense.

### ADVANTAGES AND SUMMARY OF THE INVENTION

Accordingly, it is an object of this invention to provide a low cost, manually operable tool for increasing the rate of manual log splitting with a wedge.

It is another object of the invention to provide a manually operable device for rapid completion of log splitting with a splitting wedge for use when the wedge is embedded in a log.

It is a further object of the invention to provide such a log-splitting device with which a twisting force is not produced between handles of the device when force is applied to them for operation.

It is yet a further object and advantage of the present invention to provide an article of manufacture and method for splitting logs using two people.

It is yet a further object and advantage of the present invention to provide a kit for splitting logs, the kit comprising a log splitter as described herein, a sledge hammer and one or 2 wedges, the wedges having optionally one or two different sizes.

The attainment of these and related objects may be achieved through use of the novel, manually operable log splitter herein disclosed. This log splitter has a pair of jaws pivotable about a point. Each jaw is connected to a handle extending away from its associated jaw from the pivot point. The handles are substantially longer than the length of each jaw. Each jaw has a tip smaller than a width of a splitting wedge with which the log splitter is used. The jaws and handles are dimensioned and configured for insertion beside the splitting wedge when the wedge is embedded in a log. Manual application of a force on each handle outward from the pivot point by a user provides sufficient force for splitting the log. The handles and jaws preferably have coplanar longitudinal axes about the pivot point.

In operation, fireplace length logs, for example 18 inches (46 cm) to 24 inches (61 cm) long, are easily split after a wedge has been used to start the split. The log splitter of this invention may be used in place of multiple blows on a splitting wedge, or utilized only when the wedge is stuck and embedded in a log being split. In either instance, the ease with which the splitting operation may be completed through use of the manually-operable log splitter of this invention results in substantially faster manual log splitting.

The attainment of the foregoing and related objects, advantages and features of the invention should be more readily apparent to those skilled in the art, after review of the following more detailed description of the invention and the embodiments thereof, from the claims and from the accompanying drawings, in which:

### BRIEF DESCRIPTION OF THE DRAWINGS

FIG. 1 is a perspective view of a manually operable log splitter 10 of the present invention in accordance with the invention, showing its manner of use.

FIG. 2 is a similar perspective view, but of manually operable log splitter 10 of the present invention at the conclusion of its use to split a log.

FIG. 3 is a cross-section view, taken along the line 3-3′ of the manually operable log splitter 10 of the present invention in FIG. 1.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

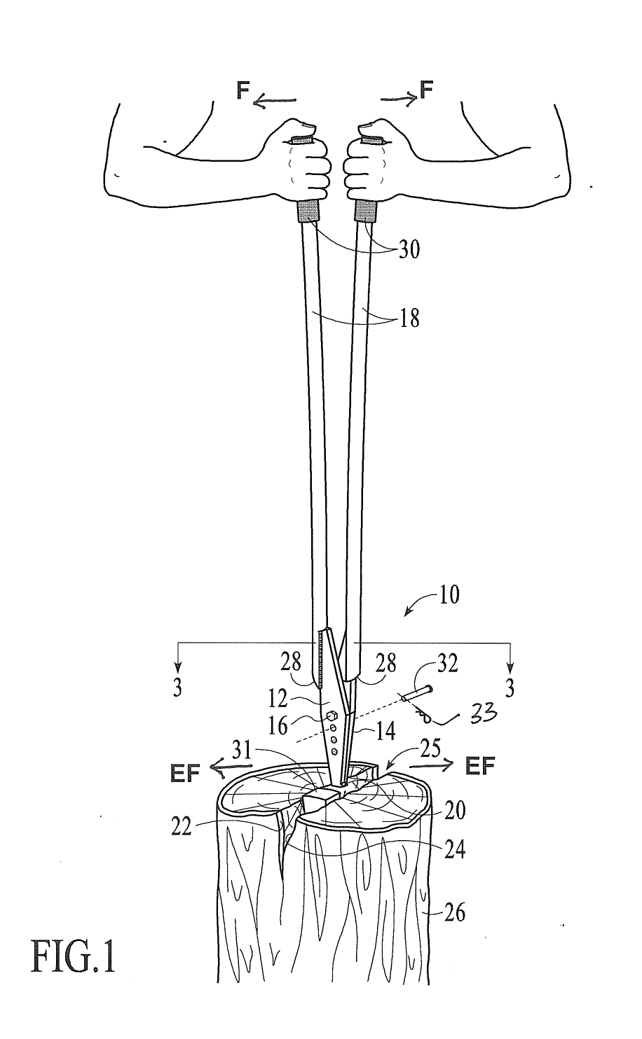

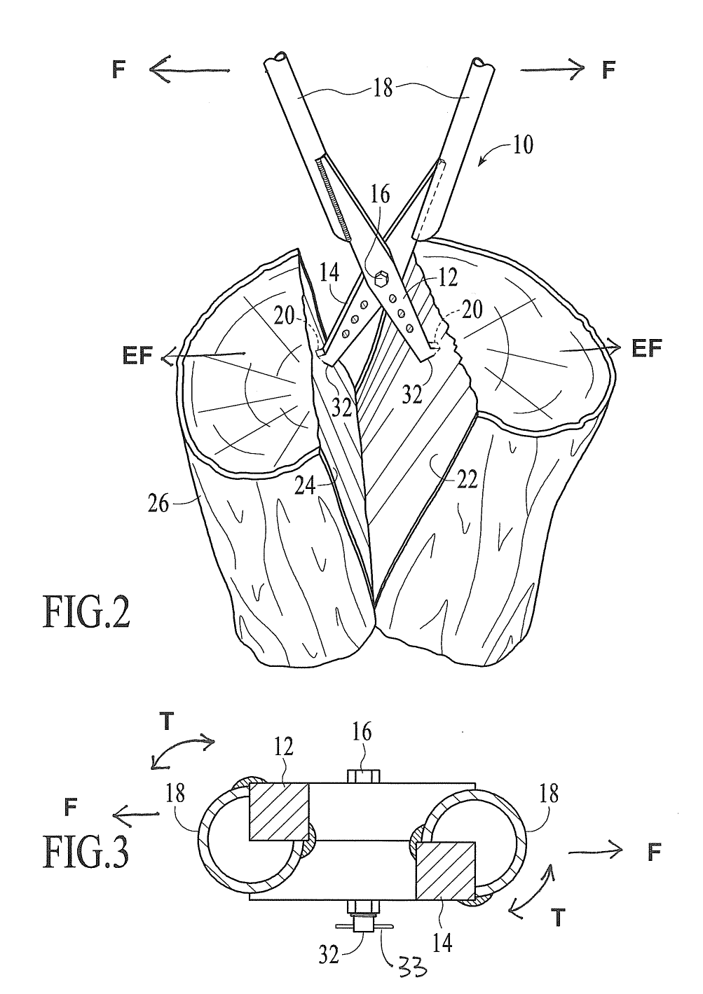

FIG. 1 is a perspective view of a manually operable log splitter 10 of the present invention in accordance with the invention, showing its manner of use. FIG. 2 is a similar perspective view, but of manually operable log splitter 10 of the present invention at the conclusion of its use to split a log. Turning now to the drawings, more particularly to FIGS. 1 through 3, there is shown a manually operable log splitter 10 of the present invention. As best shown in FIG. 1, jaws 12 and 14 are pivoted about at pin 16, which fastens them together, either permanently or detachably. A pair of identical handles 18 extend from the pivot pin 16 away from the jaws 12 and 14. Optionally, handles 18 can be bent slightly such that it is more ergonomically efficient for user to assert force F required to split the log 26. The handles 18 may be fabricated of, for example, tubular steel that is desirably galvanized for rust resistance, stainless steel and other durable materials. Jaws 12 and 14 may be fabricated from a relatively soft steel and permanently coupled to the handles 18 by processes such as welding, glue, mechanical fastening means, etc. Jaws 12 and 14 also desirably each has a projecting tip 20 for engaging a log 26 on its opposing faces 22 and 24 of log 26. If desired, the projecting tips 20 and adjacent portions of the jaws 12 and 14 may be annealed and quench-cooled in oil to give a hard face. Handles 18 are beveled at 28 where they are permanently coupled and/or welded to the jaws 12 and 14 to facilitate insertion of the manually operable log splitter 10 of the present invention deeply into split 25 of log 20, which is sometimes required.

FIG. 3 is a cross-section view, taken along the line 3-3′ of the manually operable the manually operable log splitter 10 of the present invention in FIG. 1. As best shown in FIG. 3, handles 18 and their associated jaws 12 and 14 have coplanar longitudinal axes about the pivot pin 16, so that the application of force F to the handles 18 of the present invention 10 in operation will not produce a twisting force T in the log splitter. Grips 30 are provided at the ends of handles 18, remote from the pivot pin 16. As a safety and convenience feature, a safety pin 32 is inserted through mating holes 40 and 42 in the jaws 12 and 14 and locked by a locking pin 33 to hold the jaws 12 and 14 in a closed position when the present invention 10 is not in use. Optionally, a bail on the handles 18 near grips 30 could also be used for this purpose.

As best shown in FIGS. 1 and 2, optionally pivot pin 16 is fastened detachably on jaws 14 and 16 of the present invention 10. When desired, user can easily detach pivot pin 16 and reattach pivot pin 16 on any of the mating holes 40 and 42 on jaws 14 and 16. The purpose of the switching is to adjust the effort force EF produced to split log 26. In theory, as pivot pin 16 moving down jaws 12 and 14, effort force EF will increase with the constant force F provided by user. In one embodiment, the safety pin 32 and locking pin 33 couple can be applied to unused mating holes 40 and 42 to lock the entire manually operable log splitter 10 when not in use.

As best shown in FIGS. 1 and 2, when in operation, the jaws 12 and 14 in the closed position, are inserted beside wedge 31 embedded in the log 26. Tips 32 of the jaws 12 and 14 therefore have a width less than the width 34 of the wedge 31. With a typical wedge 31 having a width of about 1½ inches or 3.8 cm, tips 32 of the jaws 12 and 14 should have a width of about one inch or 2.5 cm. Outward force F is then applied against the handles 18 to move the jaws 12 and 14 to the position as best shown in FIG. 2, thus applying sufficient effort force EF to split the partially split log 26. In most situations, these forces F may be applied by holding the present invention 10 transverse to the user. Slightly more force F may be obtained by pointing one handle 18 away from the user or by having one person pulling on each handle 18. With certain hand-to-split logs 26, it is necessary to apply force F to the handles 18 more than once and work the jaws 12 and 14 further into the log 26 between each application of force F. The bevel at facilitates such insertion. Moreover, user can move the position of pivot pin 16 lower on handles 18 in order to apply more effort force EF to split the log 26.

For an user of average height, the manually operable log splitter 10 of the present invention should have an overall length of about 48 inches or 122 cm with a distance from the beveled portion 28 of the handles 18 to tip 32 of the jaws 12 and 14 of about 8 inches or 20 cm. It should now be apparent to those skilled in the art that a manually-operable log splitter 10 is capable of achieving the stated objects of the invention has been provided. The present invention 10 will complete the splitting of a log 26 having a splitting wedge 31 embedded in the log rapidly and conveniently. As a result, logs 26 may be split manually with the assistance of the present invention 10 at a substantially more rapid rate than by using conventional techniques to remove a wedge 31 that is embedded in a log 26 being split.

As mentioned above, the manually-operable log splitter 10 of the present invention may be employed using two people. When used by two people simultaneously, it becomes more efficient and effective in splitting larger and greater numbers of logs.

Furthermore, a kit for splitting logs contains manually-operable log splitter 10 as described herein, a sledge hammer and one or 2 wedges, the wedges having optionally one or two different sizes. Providing and using a kit comprising the manually-operable log splitter 10, a hammer and a wedge will enable one or more users to better split logs as desired.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A manually-operable log splitter for use with a splitting wedge, which comprises a pair of jaws having a given length and being pivotable about a point, each jaw being connected to a handle extending away from its associated jaw from the pivot point, the handles being substantially longer than the length of the jaws, each jaw having a tip smaller than the width of the splitting wedge, the jaws and handles being dimensioned and configured for insertion beside the splitting wedge when embedded in a log, manual application of force on each handle outward from the pivot point to pull the handles apart by a user separating the jaws to provide sufficient force for splitting the log.

2. A manually-operable log splitter for use to split a log, the manually-operable log splitter further comprising:
a pair of identical jaws being pivoted detachably at a fulcrum, the jaws further connected to a handle extending away from its associated jaw, the handles and jaws further having coplanar longitudinal axes about the fulcrum, the tip of each jaw further having a sharp and hard side protruding tip for securing grip on a splitting surface on the log;
a pair of grips being attached permanently at the adjacent end of each of the handles;
a plurality of circular through holes of equal diameter on each of the jaws positioned on the same vertical axis of the fulcrum; and
a detachable locking pin matching to the circular through holes further having an operable locking means.

3. The manually-operable log splitter of claim 1 in which each jaw has a projection facing outward for engaging the log.

4. The manually-operable log splitter of claim 1 in which said handles and jaws have coplanar longitudinal axes about the pivot point.

5. The manually-operable log splitter of claim 1 in which said handles are formed from tubular steel.

6. The manually-operable log splitter of claim 1 further comprising a means for locking said jaws in a closed position.

7. The manually-operable log splitter of claim 2, in which the handles have a length in the approximate range of 30 to 50 inches.

8. The manually-operable log splitter of claim 2, in which the jaws have a length in the approximate range of 5 to 15 inches.

9. The manually-operable log splitter of claim 2, in which the jaws have a combined width from adjacent side protruding tips in the approximate range of 0.5 to 3 inches.

10. The manually-operable log splitter of claim 2, in which the handles are slightly bent.

11. A method of splitting a log, the method comprising the following steps:
Driving a splitting wedge into a log to create a slightly split opening in the log;
Obtaining a manually-operable log splitter comprising a pair of jaws having a given length and being pivotable about a point, each jaw being connected to a handle extending away from its associated jaw from the pivot point, the handles being substantially longer than the length of the jaws, each jaw having a tip smaller than the width of the splitting wedge, the jaws and handles being dimensioned and configured for insertion beside the splitting wedge when embedded in a log, manual application of force on each handle outward from the pivot point to pull the handles apart by a user separating the jaws to provide sufficient force for splitting the log;
Inserting tips of the jaws inside the split opening, making sure the manually-operable log splitter is in a closed position;
Exerting outward force on handle to open the manually-operable log splitter; and
Splitting the log.

12. The method of splitting a log of claim 11 further comprising the steps of:
Closing the jaws of the manually-operable log splitter;
Moving the tips of the jaws further down partially split log opening;
Re-exerting outward force on handle to open the jaws of the manually-operable log splitter; and
Splitting the log further.

13. The method of splitting a log of claim 11 in which two people operate the manually-operable log splitter simultaneously to increase ease and efficiency of splitting logs.

14. A kit for splitting logs, the kit comprising:
A. A manually-operable log splitter for use to split a log, the manually-operable log splitter further comprising:
a pair of identical jaws being pivoted detachably at a fulcrum, the jaws further connected to a handle extending away from its associated jaw, the handles and jaws further having coplanar longitudinal axes about the fulcrum, the tip of each jaw further having a sharp and hard side protruding tip for securing grip on a splitting surface on the log;
a pair of grips being attached permanently at the adjacent end of each of the handles;
a plurality of circular through holes of equal diameter on each of the jaws positioned on the same vertical axis of the fulcrum; and
a detachable locking pin matching to the circular through holes further having an operable locking means;
B. A hammer for driving one or more wedges into the log prior to splitting; and
C. A wedge.
